(19) United States
(12) Patent Application Publication
(10) Pub. No.: US 2019/0164238 A1
(43) Pub. Date: May 30, 2019

(54) GRAPHICAL USER INTERFACE TO COMPARE VALUES OF COMPONENTS

(71) Applicant: GOOGLE LLC, Mountain View, CA (US)

(72) Inventors: James Carter, Mountain View, CA (US); Rodney S. Daughtrey, Cambridge, MA (US)

(21) Appl. No.: 16/166,048

(22) Filed: Oct. 19, 2018

Related U.S. Application Data
(63) Continuation of application No. 13/804,831, filed on Mar. 14, 2013, now abandoned.
(60) Provisional application No. 61/759,236, filed on Jan. 31, 2013.

(51) Int. Cl. G06Q 50/14; G06T 11/20; G06F 3/0484; G06F 3/0482; G06Q 30/06

(52) U.S. Cl. CPC G06Q 50/14; G06T 11/206; G06F 3/04842; G06T 2200/24; G06F 3/0482; G06Q 30/0641; G06F 3/04847

(57) ABSTRACT

The disclosure describes computer-implemented methods, software, and systems to render graphical user interfaces to compare values of components. One computer-implemented method includes determining a geographic origin for a received request, selecting a plurality of proposed destinations and, for each proposed destination, identifying information, filtering the selected plurality of proposed destinations based upon at least one filtering rule based at least in part upon the determined geographic origin to generate a set of filtered proposed destinations, initiating a presentation of the information for the set of filtered proposed destinations, wherein each proposed destination of the filtered proposed destinations is associated with an interactive informational element representing the proposed destination, receiving a hover event associated with a particular interactive informational element, and initiating a presentation of an interactive value-date summary graph for the proposed destination associated with the particular interactive informational element.

### TECHNICAL FIELD

The technology disclosed herein relates to presenting graphical user interfaces, and more particularly to presenting graphical user interfaces to compare values of components.

### BACKGROUND

Selecting a destination as part of a planning session involves making choices regarding multiple components. Often, a user must pose planning queries to multiple component systems, each component system used to discover and make choices for one of multiple possible components. In response to a planning query, a particular component system returns, in various possible forms, information pertaining to an associated component, such as values based on scarcity, dates, description, requirements, and the like.

### SUMMARY

The present disclosure relates to computer-implemented methods, software, and systems for comparing values of components. A geographic origin is determined for a received request to start a planning session. A number of proposed destinations are selected, and for each, information is identified. The information includes a location indicator, a date range, and a lowest value based on scarcity associated with the date range. The selected proposed destinations are filtered based upon at least one filtering rule. The filtering rule is based partially upon the determined geographic origin and is used to generate a set of filtered proposed destinations. A presentation of the filtered proposed vacation destinations is initiated. Each proposed destination is associated with an interactive informational element. A received hover event associated with a particular interactive informational element initiates the presentation of an interactive value-date summary graph for the proposed destination associated with the particular interactive informational element.

The present disclosure relates to computer-implemented methods, software, and systems for comparing costs of components. One computer-implemented method includes determining a geographic origin for a received request to initiate a planning session; selecting, by operation of a computer, a plurality of proposed destinations; and, for each proposed destination of the plurality of proposed destinations, identifying information comprising a location indicator, a date range, and a lowest value based on scarcity associated with the date range; filtering, by operation of a computer, the selected plurality of proposed destinations based upon at least one filtering rule based at least in part upon the determined geographic origin to generate a set of filtered proposed destinations; initiating, by operation of a computer, a presentation of all or part of the information for the set of filtered proposed destinations, wherein each proposed destination of the filtered proposed destinations is associated with an interactive informational element representing the proposed destination; receiving a hover event associated with a particular interactive informational element; and initiating a presentation of an interactive value-date summary graph for the proposed destination associated with the particular interactive informational element.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features:

A first aspect, combinable with the general implementation, wherein the geographic origin is determined by at least one of data entry, analysis of an Internet protocol (IP) address, location-based data obtained from a mobile device, global positioning system (GPS) data, or cellular network triangulation data.

A second aspect, combinable with the general implementation, wherein the proposed destinations are filtered based one or more particular values associated with user profile data.

A third aspect, combinable with the general implementation, wherein the at least one filtering rule is used to weight each proposed destination.

A fourth aspect, combinable with the general implementation, further comprising updating the information associated with the proposed destination upon receiving a selector adjustment event for a selector associated with the interactive value-date summary graph.

The subject matter described in this specification can be implemented in particular implementations so as to realize one or more of the following advantages. First, a user can view multiple components within a single component graphical user interface (GUI) of a planning computer system (PCS). This allows the user to conveniently use one PCS instead of interacting with multiple component systems to plan the overall schedule. Second, the user can compare total values for various destinations based upon selected components for a specific date or across a given date range. Third, the user can compare the relative value of a change to a particular component to the various destinations. Fourth, the user can compare the relative value of chosen components across time. Fifth, the user can select destinations by specific cities/destinations and within some distance/time of a geographic origin. Sixth, the user can view generated destinations by various filtering criteria, such as values based on scarcity, popularity, friends, and/or other suitable filter criteria. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a block diagram illustrating an example distributed computing system for comparing costs of vacation components.

FIG. 2 illustrates an example screenshot of a vacation component graphical user interface (VCG) according to one implementation.

FIG. 3 illustrates an example screenshot of results populated into a VCG due to entered search key words according to one implementation.

FIG. 4 illustrates an example alternative screenshot of results populated into a VCG due to entered search key words according to one implementation.

FIG. 5 illustrates an example screenshot of selectable options associated with an entry element according to one implementation.

FIG. 6A illustrates an example screenshot of an expanded “Where to go” entry element according to one implementation.

FIG. 6B illustrates an example screenshot of an expanded “Where to go” entry element with selected countries according to one implementation.

FIG. 6C illustrates an example screenshot of an expanded “Where to go” entry element using a within some distance from home option according to one implementation.

FIG. 7 illustrates an example screenshot of an expanded “When to go” entry element according to one implementation.

FIG. 8 illustrates an example screenshot of an expanded “Flights” entry element according to one implementation.

FIG. 9 illustrates an example screenshot of an expanded “Hotel” entry element according to one implementation.

FIG. 10 illustrates an example screenshot of provided details for a selected proposed vacation destination.

FIG. 11 illustrates an example screenshot of alternative provided details for a selected proposed vacation destination.

FIG. 12 is a flow chart of an example method for comparing costs of vacation components.

FIG. 13 is a flow chart of an example alternative method for comparing costs of vacation components.

FIG. 14 is a flow chart of an example alternative method for comparing costs of vacation components.

Like reference numbers and designations in the various drawings indicate like elements.

### DETAILED DESCRIPTION OF THE EXAMPLES

### Overview

The disclosure generally describes computer-implemented methods, software, and systems for comparing costs of vacation components.

Traveling to a destination as part of a vacation involves making choices regarding multiple components of the vacation, such as transportation, lodging, destination, activities, and the like. Often, a traveler must pose planning queries to multiple component systems, such as air travel, car rental, ticket/permit providers, and/or attraction web sites, each component system used to discover and make choices for one of multiple possible components of the vacation. In response to a planning query, a particular component system returns, in various possible forms, information pertaining to an associated vacation component, such as price, dates, description, requirements, and the like. Having to interact with multiple component systems can be cumbersome, introduce errors and frustration into vacation planning, and result in missed opportunities, overpayment, and the like that may result from unknown discounts, packages, and special arrangements available if the user were aware of contextual relationships between the vacation components.

A travel planning computer system (TPCS) is an integrated and secure vacation planning environment, often in the form of a web-based user interface, and is designed to aggregate and present vacation component information through one or more vacation component graphical user interfaces (GUIs) (VCGs) providing, among other things, costs and one or more contextual relationships between the components of a particular vacation. The TPCS may present information from diverse sources on mobile or other devices in a unified and structured way, and provide additional services, such as an internal search engine, e-mail, news, navigation tools, and various other features to enhance planning of a particular vacation.

### Example System Architecture and Processes

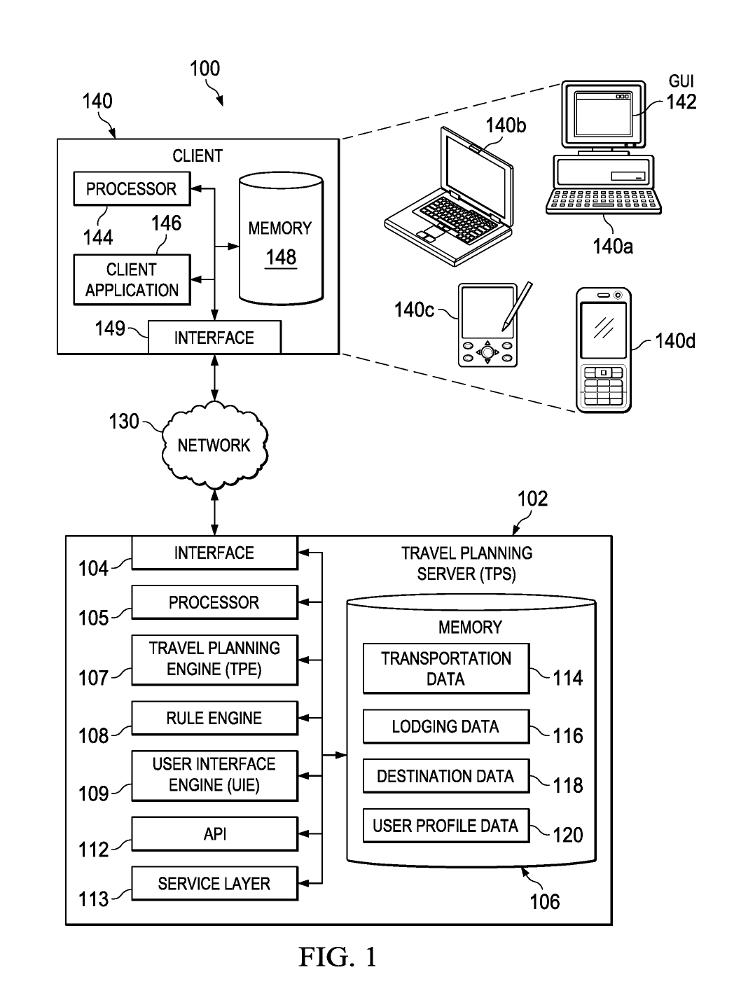

FIG. 1 is a block diagram illustrating an example distributed TPCS 100 (hereinafter “TPCS 100”) for comparing costs of vacation components. The illustrated TPCS 100 includes or is communicably coupled with a travel planning server (TPS) 102 and a client 140 that communicate across a network 130.

At a high level, the TPS 102 is an electronic computing device operable to receive, transmit, process, store, or manage data and information associated with the TPCS 100 using a GUI 142 providing a TPCS 100 user (hereinafter “user”) with an efficient, user-friendly, and secure presentation of data provided by or communicated within the TPCS 100. Specifically, the TPS 102 provides various integrated tools and associated functionality, for example, through a particular VCG used to compare, among other things, costs of vacation components by selecting, defining, editing, and/or confirming choices for components that make up a particular vacation.

The TPS 102 is responsible for receiving application requests, for example vacation planning requests, from one or more client applications 146 associated with a particular client 140 of the TPCS 100 and responding to the received requests by processing the received vacation planning requests in a travel planning engine (TPE) 107, rule engine 108, and/or user interface engine (UIE) 109, and sending an appropriate response back to the requesting client application 146. In addition to requests from the client 140, requests associated with a particular TPE 107, rule engine 108, and/or UIE 109 may also be sent from internal users, external or third-party users, other automated applications (not illustrated), as well as any other appropriate entities, individuals, systems, or computers associated with the TPS 102 and/or other components of the TPCS 100. According to one implementation, the TPS 102 may also include or be communicably coupled with an e-mail server, a web server, a caching server, a streaming data server, and/or other suitable server.

At least a portion of the TPE 107, rule engine 108, and/or UIE 109 is executed using requests/responses sent from/to a client 140 within and communicably coupled to the illustrated TPCS 100 using network 130. In some implementations, requests/responses can be sent directly to TPS 102 from a user accessing TPS 102 directly. In some implementations, the TPS 102 may store a plurality of TPE 107, rule engine 108, and/or UIE 109 instances. In some implementations, the TPS 102 may comprise a web server, where one or more of the components of TPS 102 represent web-based applications accessed and executed by the client 140 using the network 130 or directly at the TPS 102 to perform the programmed tasks or operations of the various components of the TPS 102.

In some implementations, any and/or all of components of the TPS 102, both hardware and/or software, may interface with each other and/or an interface 104 (described below) using an application programming interface (API) 112 and/or a service layer 113. The API 112 may include specifications for routines, data structures, and object classes. The API 112 may be either computer language-independent or -dependent and refer to a complete interface, a single function, or even a set of APIs. The service layer 113 provides software services to the TPCS 100. The functionality of the TPS 102 may be accessible for all service consumers using this service layer. Software services provide reusable, defined business functionalities through a defined interface. For example, the interface may be software written in JAVA, C++, or other suitable language providing data in extensible markup language (XML) format or other suitable format.

While illustrated as an integrated component of the TPS 102 in the TPCS 100, alternative implementations may illustrate the API 112 and/or service layer 113 as a stand-alone component in relation to other components of the TPCS 100. Moreover, any or all parts of the API 112 and/or service layer 113 may be implemented as a child or sub-modules of another software module, enterprise application, or hardware module without departing from the scope of this disclosure.

The TPS 102 includes an interface 104. Although illustrated as a single interface 104 in FIG. 1, two or more interfaces 104 may be used according to particular needs, desires, or particular implementations of the TPCS 100. The interface 104 is used by the TPS 102 for communicating with other systems in a distributed environment—including within the TPCS 100—connected to the network 130; for example, the client 140 as well as other systems (not illustrated) communicably coupled to the network 130. Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the TPCS 100.

The TPS 102 includes a processor 105. Although illustrated as a single processor 105 in FIG. 1, two or more processors may be used according to particular needs, desires, or particular implementations of the TPCS 100. Generally, the processor 105 executes instructions and manipulates data to perform the operations of the TPS 102. Specifically, the processor 105 executes the functionality required to compare costs of vacation components.

The TPS 102 also includes a memory 106 that holds data for the TPS 102. Although illustrated as a single memory 106 in FIG. 1, two or more memories may be used according to particular needs, desires, or particular implementations of the TPCS 100. While memory 106 is illustrated as an integral component of the TPS 102, in alternative implementations, memory 106 can be external to the TPS 102 and/or the TPCS 100. In some implementations, the memory 106 holds/manages the description and/or data for all objects in the TPS 102, includes one or more instances of transportation data 114, lodging data 116, destination data 118, and/or user profile data 120.

The transportation data 114 is data identifying available forms of transportation associated with various components of a vacation. For example, in some implementations, the transportation data 114 can be associated with air carriers, trains, boats/ships, subways, taxi service, bus service, shuttle services, and the like. For a particular air carrier, the transportation data 114 may include and/or indicate where to access an air carrier name, address, identification number, abbreviation, countries of service, airport hub, available flights, flight fares, discounts, and/or any other suitable data with respect to an air carrier and provided service. For example, the particular air carrier may have data stored in the at least one air-carrier data 114 instance as the name “Airborne Rider Airlines,” address “1234 Airport Row, Flight City, Tex. 75001,” identification number “3170,” abbreviation “ARA,” countries of service “US and UK,” airport hub “DFW,” and flight schedules/fares. For a particular taxi service, the transportation data 114 may include taxi service name, address, service zone, available taxis, fares, discounts, and/or any other suitable data with respect to a taxi service. Other representations and types of transportation data 114 associated with suitable transportation methods, services, and/or providers may be used and/or stored without departing from the scope of the disclosure.

In some implementations, the transportation data 114 is accessed by the TPE 107 and/or the rule engine 108. For example, the TPE 107 and/or the rule engine 108 can access, analyze, and/or process the transportation data 114, and subsequently use the UIE 109 to display appropriate results to a user using a particular client application 146. In other implementations, the transportation data 114 can be accessed by a remote access system or software, a local or remote client 140, or other suitable TPCS 100 component.

The lodging data 116 is data identifying available forms of lodging associated with various components of a vacation. For example, in some implementations, the lodging data 116 can be associated with hotels, motels, bed-and-breakfasts, private rooms for rent, camp grounds, recreational vehicle (RV) parks, and the like. For a particular hotel, the lodging data 116 may include and/or indicate where to access hotel name, address, branch number, corporate contact, general manager contact, number of rooms, types of rooms, room rates, room rate schedules based on dates and/or local events, check-in/out times, smoking classifications, available parking, local attractions near the hotel, and/or any other suitable data with respect to a hotel and provided hotel service. For a bed-and-breakfast, the lodging data 116 may include name, address, available dates, room rates, provided services, and/or any other suitable data with respect to a bed-and-breakfast. Other representations and types of lodging data 116 associated with suitable lodging, services, and/or providers may be used and/or stored without departing from the scope of the disclosure.

In some implementations, the lodging data 116 is accessed by the TPE 107 and/or the rule engine 108. For example, the TPE 107 and/or the rule engine 108 can access, analyze, and/or process the lodging data 116, and subsequently use the UIE 109 to display appropriate results to a user using a particular client application 146. In other implementations, the lodging data 116 can be accessed by a remote access system or software, a local or remote client 140, or other suitable TPCS 100 component.

The destination data 118 is data identifying available destinations associated with various components of a vacation. For example, in some implementations, the destination data 118 can be associated with geographic regions, countries, cities, towns, and the like. For example, for a particular city, the destination data 116 may include and/or indicate where to access name, geographic coordinates, population, demographics, weather data, major highways, available airports, train stations, bus stops, location industry, location attractions, special events, tax rates, laws, history, and/or any other suitable data with respect to a city. Other representations and types of destination data 118 associated with suitable destinations, services, and/or providers may be used and/or stored without departing from the scope of the disclosure.

In some implementations, the destination data 118 is accessed by the TPE 107 and/or the rule engine 108. For example, the TPE 107 and/or the rule engine 108 can access, analyze, and/or process the destination data 118, and subsequently use the UIE 109 to display appropriate results to a user using a particular client application 146. In other implementations, the destination data 118 can be accessed by a remote access system or software, a local or remote client 140, or other suitable TPCS 100 component.

The user profile data 120 is data associated with a particular user and/or group of users. In some implementations, the user profile data 120 may include, for example, name, address, identification number (such as a U.S. Social Security Number), age, birthdate, place of birth, nationality, race, religion, sex, marital status, relationship status, education level, employer, interests, travel history, prior TPCS 100 system choices made, data about friends and/or acquaintances, and other suitable user profile data. In one example, the user profile data 120 could be used by the TPE 107, rule engine 108, and or UIE 109 to make proposals to a user about potential vacation destinations. If a user indicated in past TPCS 100 transactions that they prefer beaches and mountain destinations, the TPCS 100 could provide current beach and mountain destinations with a higher weighting in deciding which destinations to present to a user. In some implementations, the user profile data 120 can also be used to filter and/or recommend destinations. For example, a married female planning a vacation may be presented with “couples” type vacation destinations or bed-and-breakfast lodging, while a single/no-relationship female can be presented with “singles” type vacation destinations or hotels with data indicating popularity among single adults. While presenting “couples” type vacation destinations may be appropriate to a non-married/in-a-relationship adult, a “couples” type vacation destination would generally not be appropriate for a non-married/no-relationship adult.

In some implementations, the user profile data 120 can be planned vacations and associated vacation components/costs. In the case of a user planning a vacation without a specific user profile, the TPS 102 can provide a temporary or default user profile data 120 instance or other suitable data structure to hold appropriate data, settings, values, and the like.

In some implementations, the user profile data 120 can be, among other things, updated, edited, and/or deleted by a suitable component of the TPCS 100, such as the TPE 107 and/or client application 146. These operations can take place whether or not the user is accessing TPCS 100. For example, the user can update their user profile data 120 using the client application 146 and/or based on vacation planning actions/choices made by other users in a user's demographic group, the user profile data 100 can be updated to indicate a greater likelihood for the user to select air travel over bus travel. A particular user's choices made using client application 146 can also result in the user profile data 120 for the particular user being modified in some way.

In some implementations, the user profile data 120 is accessed by the TPE 107 and/or the rule engine 108. For example, the TPE 107 and/or the rule engine 108 can access, analyze, and/or process the user profile data 120, and subsequently use the UIE 109 to display appropriate results to a user using a particular client application 146. In other implementations, the user profile data 120 can be accessed by a remote access system or software, a local or remote client 140, or other suitable TPCS 100 component.

The travel planning engine (TPE) 107 can be any application, program, module, process, or other software that may provide methods/functionality for, among other things, providing vacation-related component data and cost information to display on a VCG; analyzing and processing vacation planning user input provided by the UIE 109 through the VCG; providing instructions to the UIE 109; interfacing with the rule engine 108 to determine allowable vacation component combinations selections, and/or costs; requesting, analyzing/processing and displaying third-party vacation component data; providing payment services; providing vacation component confirmation services; providing ticketing/permit/license services associated with vacation components and/or other suitable methods/functionality related to vacation planning; and determining the cost of vacation components. The TPE 107 can also filter available vacation component data based upon, for example, user selections, the user profile data 120, and/or other suitable data, to present more personalized/contextually appropriate data to a particular user. In these instances, the TPE 107 can provide methods/functionality to recommend (e.g., assign a higher weighting value) particular vacation components based on user selections, the user profile data 120, and/or other suitable data. In some implementations, the TPE 107 can interface with the rule engine 108, UIE 109, and/or the client application 146, as appropriate, to provide filtering, weighting, proposals, and/or other suitable functionality.

Although illustrated as a single TPE 107 in the TPS 102, two or more TPEs 107 may be used in the TPS 102 according to particular needs, desires, or particular implementations of the specific environment. In some implementations, the TPE 107 can access, process, and/or modify data associated with the transportation data 114, lodging data 116, destination data 118, user profile data 120, and/or other suitable data.

In some implementations, a particular TPE 107 can operate in response to and in connection with at least one request received from an associated client 140. Additionally, the particular TPE 107 may operate in response to and in connection with at least one request received from other TPEs 107, including TPEs 107 associated with other TPSs 102. In some implementations, each TPE 107 can represent a web-based application accessed and executed by one or more remote clients 140 across the network 130 (e.g., through the Internet, or using at least one cloud-based service associated with the TPE 107). For example, part of a particular TPE 107 may be a web-based service associated with a TPE 107 that is remotely called, while another part of the particular TPE 107 may be an interface object or agent bundled for processing at a remote client 140. Moreover, any or all of a particular TPE 107 may be a child or sub-module of another software module (not illustrated). Still further, parts of the particular TPE 107 may be executed or accessed by a user working directly at the TPS 102, as well as remotely at a corresponding client 140. In some implementations, the transportation data 114, lodging data 116, destination data 118, and/or user profile data 120 can be defined with and stored within the TPE 107, as opposed to memory 106.

The rule engine 108 can be any application, program, module, process, or other software that may provide methods to evaluate and/or execute a rule instance (not illustrated) to support, among other things, calculating costs for, filtering, displaying, and/or selecting a vacation component, as well as other associated elements of a vacation. The rule engine 108 can also provide methods/functionality to indicate allowable combinations of vacation components and associated costs, prohibit (e.g., filter) the use/display of invalid vacation components/cost data, weight vacation components, and other suitable methods/functionally. In some implementations, the rule engine 108 can interface with the TPE 107, UIE 109, and/or the client application 146, as appropriate, to provide described functionality.

The above-mentioned rule instance may represent conditions, parameters, variables, algorithms, instructions, constraints, references, and any other appropriate information for determining allowable vacation components and/or vacation component costs. For example, the rule instance may specify that selecting a particular city as a vacation component and traveling during a particular summer month negates a discount for air travel normally available during spring months. If a user had previously selected the city and air carrier and then changed the vacation dates, the rule engine 108 would indicate to the TPE 107 and/or the UIE 109 that the currently projected cost must be updated to reflect the loss of the air travel discount due to the currently selected date range. In some implementations, a TPS 102 user, typically an administrator, can define one or more rule instances.

Although illustrated as a single rule engine 108 in the TPS 102, two or more rule engines 108 may be used in the TPS 102 according to particular needs, desires, or particular implementations of the specific environment. In some implementations, the rule engine 108 can access, process, and/or modify data associated with the transportation data 114, lodging data 116, destination data 118, user profile data 120, and/or other suitable data.

In some implementations, a particular rule engine 108 can operate in response to and in connection with at least one request received from an associated client 140. Additionally, the particular rule engine 108 may operate in response to and in connection with at least one request received from other rule engines 108, including rule engines 108 associated with other TPSs 102. In some implementations, each rule engine 108 can represent a web-based application accessed and executed by one or more remote clients 140 across the network 130 (e.g., through the Internet, or using at least one cloud-based service associated with the rule engine 108). For example, part of a particular rule engine 108 may be a web-based service associated with a rule engine 108 that is remotely called, while another part of the particular rule engine 108 may be an interface object or agent bundled for processing at a remote client 140. Moreover, any or all of a particular rule engine 108 may be a child or sub-module of another software module (not illustrated). Still further, parts of the particular rule engine 108 may be executed or accessed by a user working directly at the TPS 102, as well as remotely at a corresponding client 140. In some implementations, the transportation data 114, lodging data 116, destination data 118, and/or user profile data 120 can be defined with and stored within the rule engine 108, as opposed to memory 106.

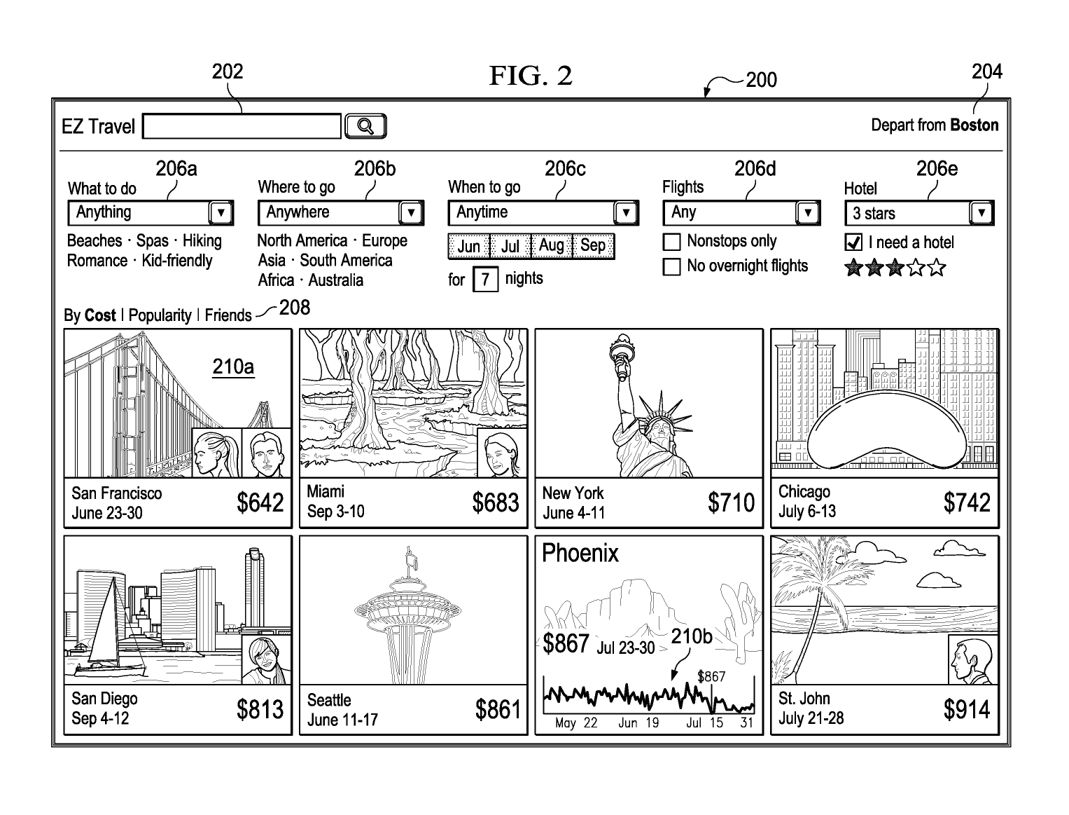

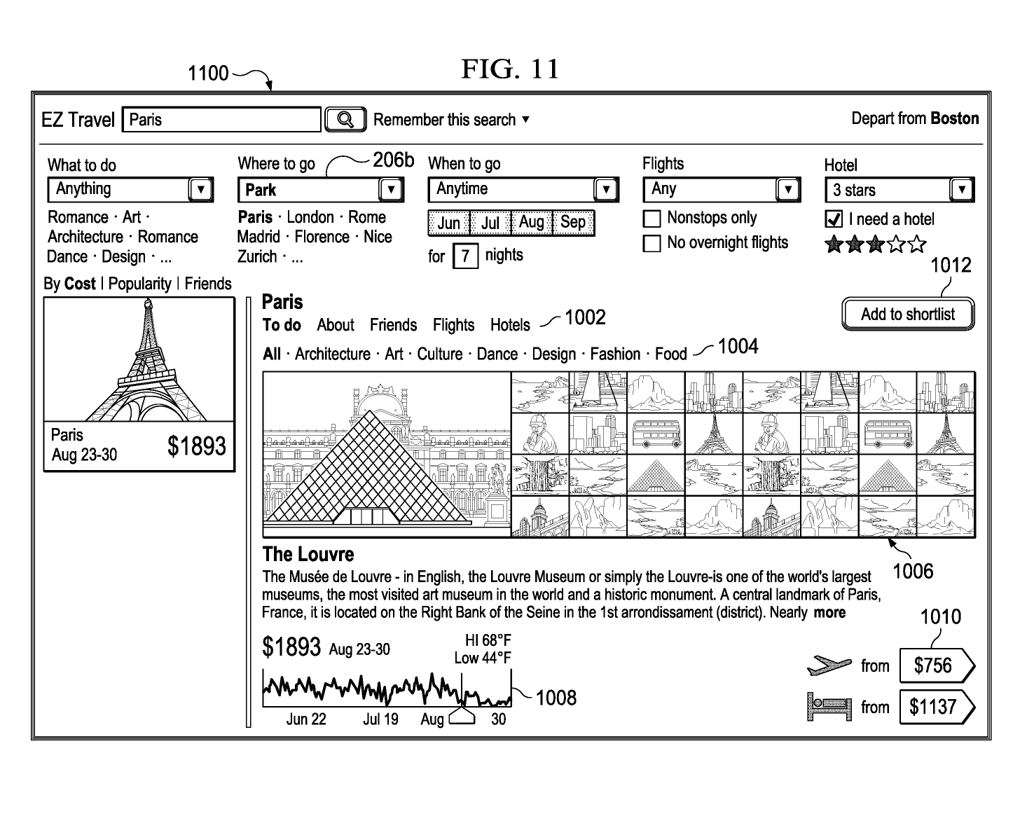

The user interface engine (UIE) 109 can be any application, program, module, process, or other software that may provide a travel planning GUI environment, for example, a VCG displayed using a client 140. FIGS. 2-5, 6A-6C, and 7-11 illustrate possible implementations of a VCG consistent with this disclosure. Other implementations consistent with this disclosure are envisioned and the provided figures are in no way intended to limit the scope of a particular GUI environment provided by the UIE 109. In some implementations, format of the VCG, displayed data, and/or other characteristics associated with the VCG can be determined from the user profile data 120 and/or other suitable data. For example, a user may prefer that displayed images are no smaller than a defined minimum dimension. The UIE 109 can then display and modify other VCG elements as necessary to meet the user's request. The UIE 109 also modifies the VCG based upon user selections. For example, if a user selects a specific city, the UIE 109 can change the VCG to display specific information about the selected city. An example of this is illustrated in FIG. 11 where a user has selected the city “Paris.” In some implementations, the UIE 109 can interface with the TPE 107, the rule engine 108, and/or the client application 146, as appropriate, to provide described functionality.

Although illustrated as a single UIE 109 in the TPS 102, two or more UIEs 109 may be used in the TPS 102 according to particular needs, desires, or particular implementations of the specific environment. In some implementations, the UIE 109 can access, process, and/or modify data associated with the transportation data 114, lodging data 116, destination data 118, user profile data 120, and/or other suitable data.

A particular UIE 109 may operate in response to and in connection with at least one request received from other UIEs 109, including a UIE 109 associated with another TPS 102, as well as other components of the TPCS 100. In some implementations, the UIE 109 can be and/or include a web server. In some implementations, each UIE 109 can represent a network-based application accessed and executed using the network 130 (e.g., through the Internet, or using at least one cloud-based service associated with the UIE 109). For example, a portion of a particular UIE 109 may be a Web service associated with the UIE 109 that is remotely called, while another portion of the UIE 109 may be an interface object or agent bundled for processing at a remote client 140. Moreover, any or all of a particular UIE 109 may be a child or sub-module of another software module or enterprise application (not illustrated) without departing from the scope of this disclosure. Still further, portions of the particular UIE 109 may be executed or accessed by a user working directly at the TPS 102, as well as remotely at a corresponding client 140.

The TPCS 100 also includes a client 140. The client 140 may be any computing device operable to connect to or communicate with the TPS 102 using the network 130. In general, the client 140 comprises an electronic computer device operable to receive, transmit, process, and store any appropriate data associated with the TPCS 100.

The illustrated client 140 further includes a client application 146. The client application 146 is any type of application that allows the client 140 to request, view, edit, and or delete content on the client 140 as well as to interact with the client 140. In some implementations, the client application 146 can be and/or include a web browser. In some implementations, the client-application 146 can use parameters, metadata, and other information received at launch to access a particular set of data, applications, etc. from the TPS 102. Once a particular client application 146 is launched, a user may interactively process a task, event, or other information associated with the TPS 102, including, among other things, comparing costs of vacation components by selecting, defining, editing, and/or confirming choices for components that make up a vacation. Further, although illustrated as a single client application 146, the client application 146 may be implemented as multiple client applications in the client 140.

The illustrated client 140 is intended to encompass any computing device such as a desktop computer 140a, laptop/notebook computer 140b, wireless data port, smart phone 140d, personal data assistant (PDA), tablet computing device 140c, one or more processors within these devices, or any other suitable processing device. For example, the client 140 may comprise a computer that includes a camera; an input device, such as a keypad, touch screen, or other device that can accept user information; and an output device that conveys information associated with the operation of the TPS 102 or the client 140 itself, including digital data, visual information, or a GUI 142, as shown with respect to the client 140.

The illustrated client 140 further includes an interface 149, a processor 144, and a memory 148. The interface 149 is used by the client 140 for communicating with other systems in a distributed environment—including within the TPCS 100—connected to the network 130; for example, the TPS 102, as well as other systems (not illustrated) communicably coupled to the network 130. The interface 149 may also be consistent with the above-described interface 104 of the TPS 102 and/or other interfaces within the TPCS 100. The processor 144 may be consistent with the above-described processor 105 of the TPS 102 and/or other processors within the TPCS 100. Specifically, the processor 144 executes instructions and manipulates data to perform the operations of the client 140, including the functionality required to send requests to the TPS 102 and to receive and process respective responses. The memory 148 may be consistent with the above-described memory 106 of the TPS 102 and/or other memories within the TPCS 100, but storing objects and/or data associated with the purposes of the client 140. Memory 148 may also be used by the TPS 102 and/or other component (not illustrated) of the TPCS 100 to store any type of data for the purposes of the client 140 or of the storing component.

Further, the illustrated client 140 includes a GUI 142. The GUI 142 interfaces with at least a portion of the TPCS 100 for any suitable purpose, including generating a visual representation in a web browser. The GUI 142 may be used to view and navigate various internal/external web pages associated with the TPS 102 as well as to interact with all provided GUIs, data, and/or functions associated with comparing costs of vacation components. In some implementations, the client application 146 may act as a GUI interface for the TPS 102, for example, a particular user interface generated by the UIE 109. In some implementations, the TPS 102 and/or other components of the TPCS 100 can transmit executable components to the client application 146 for analysis and execution on the client 140, for example, GUI code and/or data-gathering code, and/or provide content to the client application 146 for display, for example, the changing cost of a travel destination based upon a specifically selected vacation component value(s).

There may be any number of clients 140 associated with, or external to, the TPCS 100. For example, while the illustrated TPCS 100 includes one client 140 communicably coupled to the TPS 102 using network 130, alternative implementations of the TPCS 100 may include any number of clients 140 suitable to the purposes of the TPCS 100. Additionally, there may also be one or more additional clients 140 external to the illustrated portion of the TPCS 100 that are capable of interacting with the TPCS 100 using the network 130. Further, the term “client” and “user” may be used interchangeably as appropriate, without departing from the scope of this disclosure. Moreover, while the client 140 is described in terms of being used by a single user, this disclosure contemplates that many users may use one computer, or that one user may use multiple computers.

FIG. 2 illustrates an example screenshot 200 of a vacation component graphical user interface (VCG) according to one implementation. Once a user accesses the VVG, for example, through a web-based login/access screen in the client 140's native browser application, the user is presented with the VCG. In some implementations, the VCG can be presented in a default configuration, for example if the user chooses to use the VCG without a personalized account (e.g., as a “guest” or “no-account” user). The VCG can also be presented to the user with customizations that can be determined by the TPE 107, rules engine 108, and/or the UIE 109. In some instances, the user profile data 120 can be used to help configure the VCG.

As illustrated, the VCG includes a search bar 202, allowing the entry of search queries. In some implementations, the entry of a search query can modify one or more elements of the VCG.

The VCG also indicates, for purposes of vacation planning, the user's location 204 (or “geographic origin”). Here, the user's geographic origin is “Boston.” The user's location may be determined, for example, by user data entry, analysis of the user's internet protocol (IP) address, using location-based data obtained from a mobile device (e.g., using the global positioning system (GPS) or cellular triangulation data), or other suitable location-based determination method.

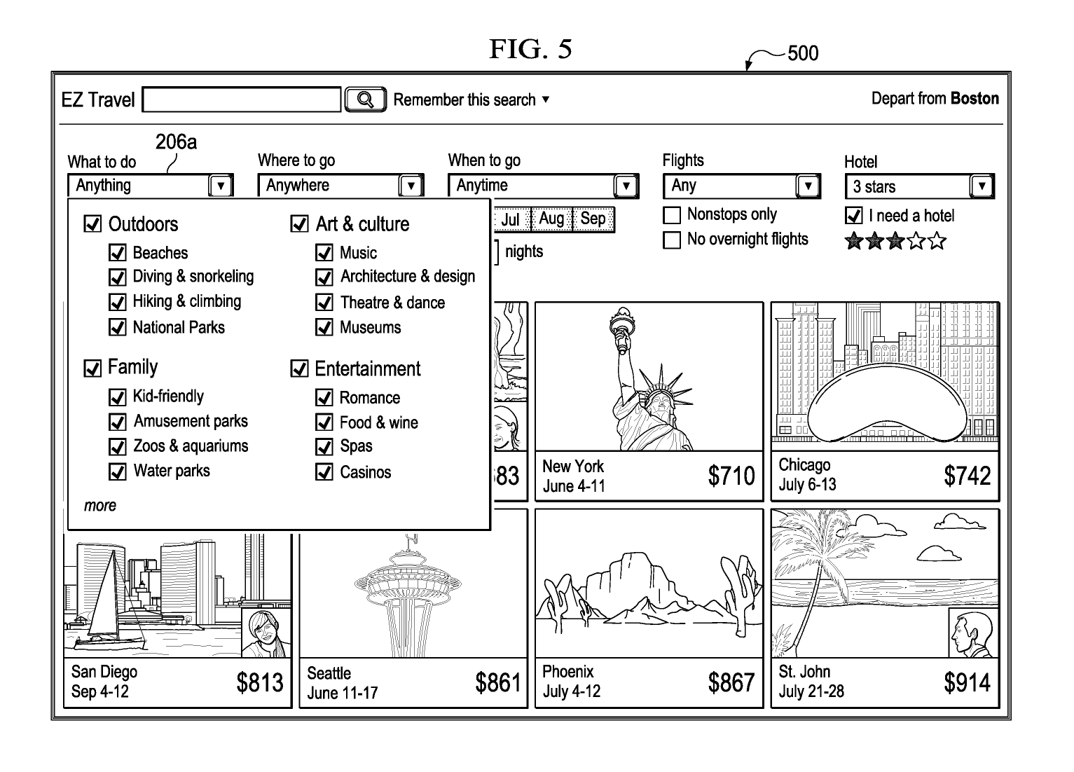

The VCG also presents to the user various vacation component entry elements (hereinafter “entry elements”). For example, the user can specify what they are interested in doing by using a “What to do” 206a entry element. Other options can include, but are not limited to, “Where to go” 206b, “When to go” 206c, “Flights” 206d, and “Hotel” 206e. In some implementations, the entry elements can be more generic. For example, the “Flights” 206d could instead be “Transportation” and provide a selection of types of transportation as well as associated options related to a chosen transportation type. In another example, “Hotel” 206e could be “Lodging.” Each component entry element provides associated values/functionality related to the associated vacation component. In addition, each entry element can provide “quick” links or values selectable without opening up a full settings dialog. For example, the “What to do” 206a entry element provides additional links below the illustrated pull-down menu offering (“Beaches,” “Spas,” “Hiking,” “Romance,” “Kid-friendly,” etc.), values that can be chosen quickly. These values may be positioned for quick access possibly due to lower cost, high popularity, user profile settings that these values are of higher interest, etc. In contrast to the quick links, an example of an expanded pull-down menu for entry element 206a is illustrated in FIG. 5.

Proposed vacation destination choices can be filtered or focused using predefined filter values 208 and or one or more filtering rule instances analyzed and/or processed by the rule engine 108. Here, the proposed vacation destinations may be filtered/focused by “Cost,” “Popularity,” or “Friends.” In some implementations, other values may be available, combinations of values may be chosen, and/or additional parameters may be set/entered for a selection (not illustrated). For the purposes of this disclosure, only the “Cost” option will be discussed, but those of skill in the art will appreciate that functionality similar to cost filtering/focusing will exist and is envisioned for other filter/focus options.

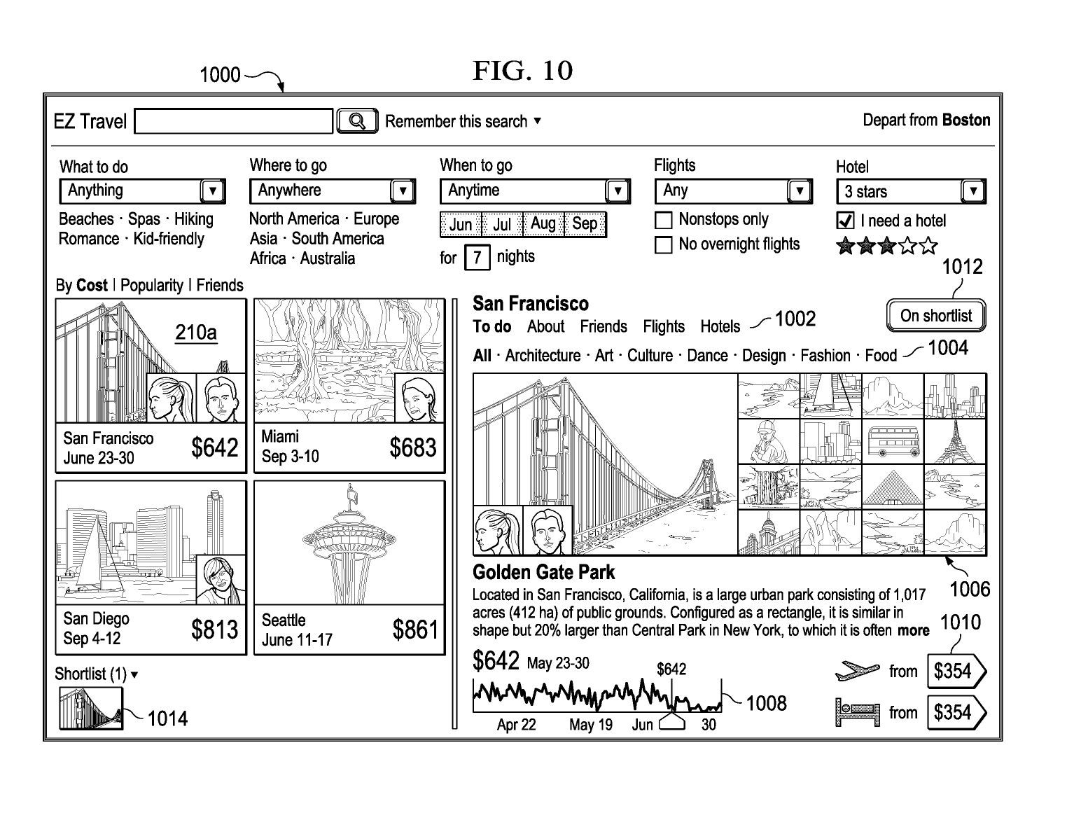

Also illustrated are a number of proposed vacation destination elements presented on the VCG. For example, proposed vacation destination element 210a displays the name of a proposed vacation destination (“San Francisco”), an associated image, a date range (“June 23-30”), an associated cost (“$642”), and in some instances one or more images of people associated with the proposed vacation destination. The people can be social networking acquaintances, other users indicated as “friends” in the user profile data 120, individuals that share similar interests as the user, or due to some other suitable indicated or determined relationship. In some implementations, proposed vacation destination elements are selectable, for example, by selecting the proposed vacation destination element with a computer mouse, touch screen, or other suitable method. Selecting a specific proposed vacation destination element can, in some implementations, direct the user to a modified VCG screen with data particular to the proposed vacation destination associated with the proposed vacation destination element. For example, FIGS. 10 and 11 indicate different forms of a VCG display focusing on a specific proposed vacation destination, here, “San Francisco” and “Paris,” respectively.

In some implementations, the proposed vacation destination elements are arranged in some order. Here, from left-to-right and top-to-bottom, listed costs for proposed vacation destinations increase. In other implementations, this order can be reversed, not exist at all, or be arranged in some other suitable manner. In the instance where a specific value for a proposed vacation destination can change, for example, after a user modification to a date as in proposed vacation destination element 210b, the other proposed vacation destination elements can be re-arranged to account for a changed cost value relative to the other proposed vacation destination elements.

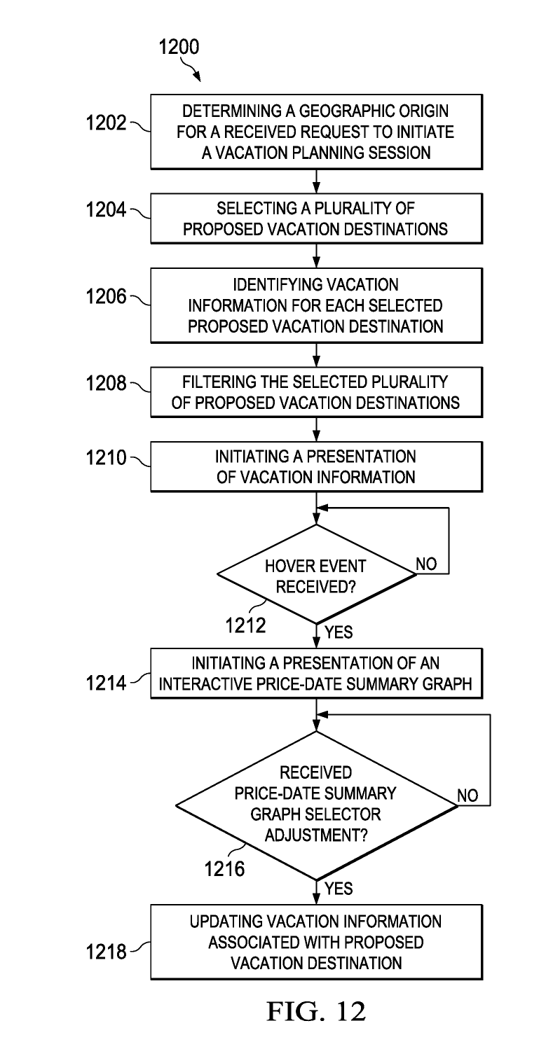

Proposed vacation destination elements can react, in some implementations, to various GUI events, such as hover events. For example, proposed vacation destination element 210b for “Phoenix” in this implementation, displays a modified associated image and an interactive price-date summary graph when a hover event associated with the proposed vacation destination element is detected. The price/data scroll field in this example mirrors the currently displayed price of “$867” for the selected time frame of “July 23-30.” In some implementations, the user is able to “scroll” or move the GUI line indicating “$867” along the interactive price-date summary graph to a lower value. For example, moving the line to the right to approximately “July 31” would result in a price slightly higher than the indicated cost of “$867.” In some implementations, the displayed price/date ranges are those values that result in the lowest cost for that proposed vacation destination within the given allowed date range as shown in “When to go” 206d. In some implementations, moving this line will focus the user on the proposed vacation destination as in FIG. 11A-11B or 12 or just change the cost determination for “Phoenix” and leave the user with the illustrated VCG as in FIG. 2.

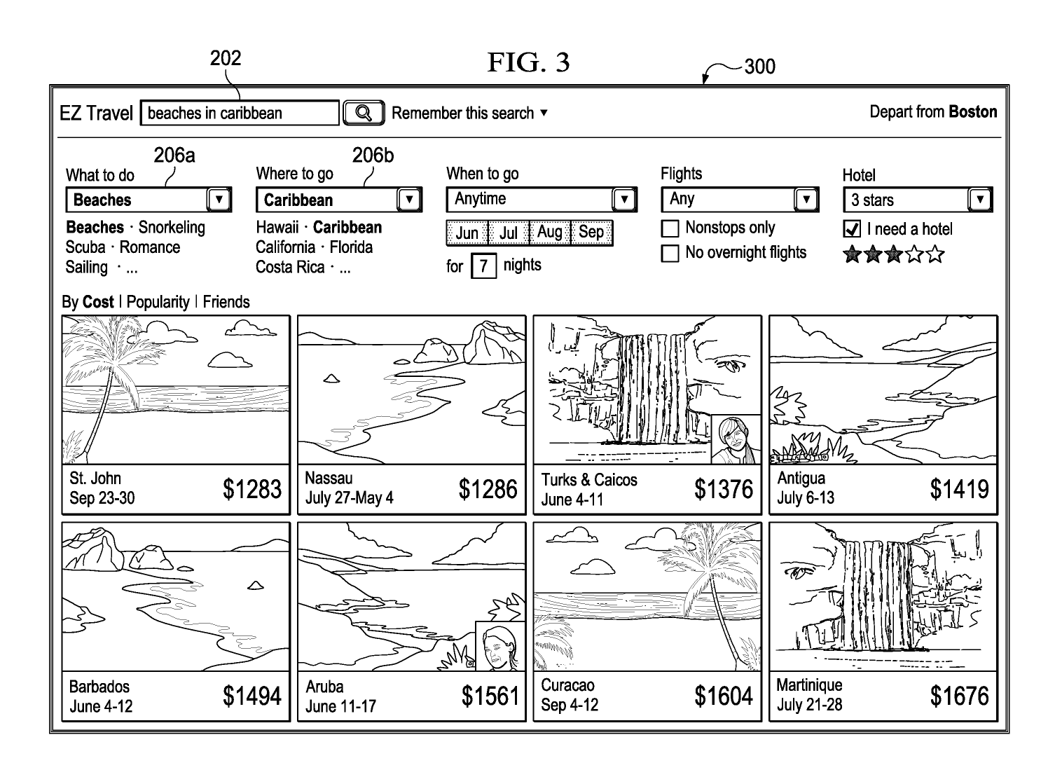

FIG. 3 illustrates an example screenshot 300 of results populated into a VCG due to entered search key words according to one implementation. In this example, the search terms “Beaches in Caribbean” are entered into search box 202. In some implementations, the typing of the key words dynamically modifies the results in the VCG as the key words are typed. In other implementations, the user must select a search “button” (such as that to the left of search box 202) to initiate the search and update the VCG values. As illustrated, the TPE 107, rule engine 108, and/or the UIE 109 can interpret the keywords and apply them to the appropriate entry element(s), here 206a and 206b, due to the fact that “Beaches” and “Caribbean” are actual (or very similar) values associated with elements 206a and 206b, respectively. Also, all illustrated proposed vacation destination elements have also been updated to reflect proposed vacation destinations associated with “Beaches” and “Caribbean.”

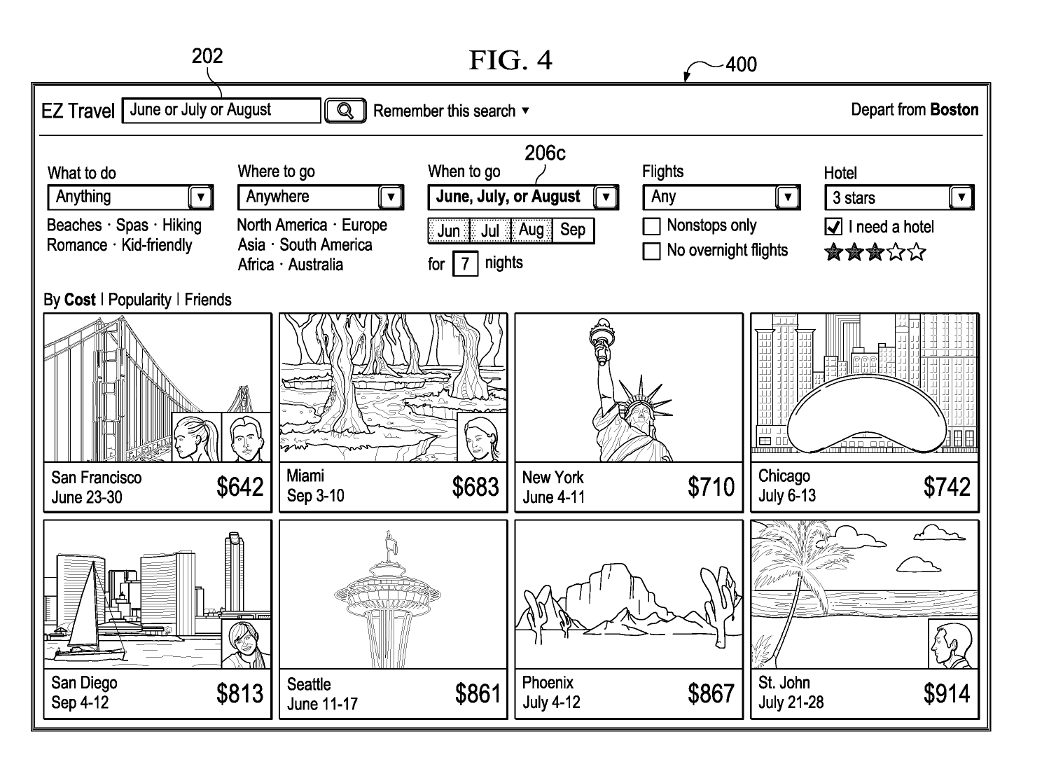

Turning to FIG. 4, FIG. 4 illustrates an example alternative screenshot 400 of results populated into a VCG due to entered search key words according to one implementation. Note that FIG. 4 illustrates similar functionality as with FIG. 3, but with the “When to go” 206c entry element and key words of “June or July or August” entered into search box 202. In this instance, the TPE 107, rule engine 108, and/or the UIE 109 can interpret the keywords and apply them to the appropriate entry element (here, 206c). Note that the quick pick month values below entry element 206c also have “Sep” indicated as not applicable (“grayed” out, as September is not included in the requested date range). Also, all proposed vacation destination elements have date values of June, July, or August.

Returning to FIG. 3, in some implementations, the user could also select the values of “Beaches” and “Caribbean” in entry elements 206a and 206b, respectively. The VCG through the TPE 107, rule engine 108, and/or the UIE 109 can interpret the key words and place the values into the search bar 202 to allow the user to textually modify the choice.

FIG. 5 illustrates an example screenshot 500 of selectable options associated with an entry element according to one implementation. As shown, entry element “What to do” 206a generates a pull-down or pop-up menu providing additional selectable options to adjust the granularity of the entry element value. For example, a user could deselect “Outdoors” and “Art & culture” and these parameters would be removed (or at least reduced in weight) from proposed vacation destination determination calculations. The “more” option at the bottom of the dialog can present the user with additional values. In some implementations, a “Select all”/“Deselect all” option can also be presented to the user to simplify selection/deselection of options. Changes made to the entry element can, in some implementations, be immediately sent to the TPE 107, rule engine 108, and/or the UIE 109 for consideration. In other instances, the changes must be manually applied (not illustrated) before having an effect on values displayed in the VCG. In some implementations, displayed options and selection values may be determined by preselected values in the user profile data 120.

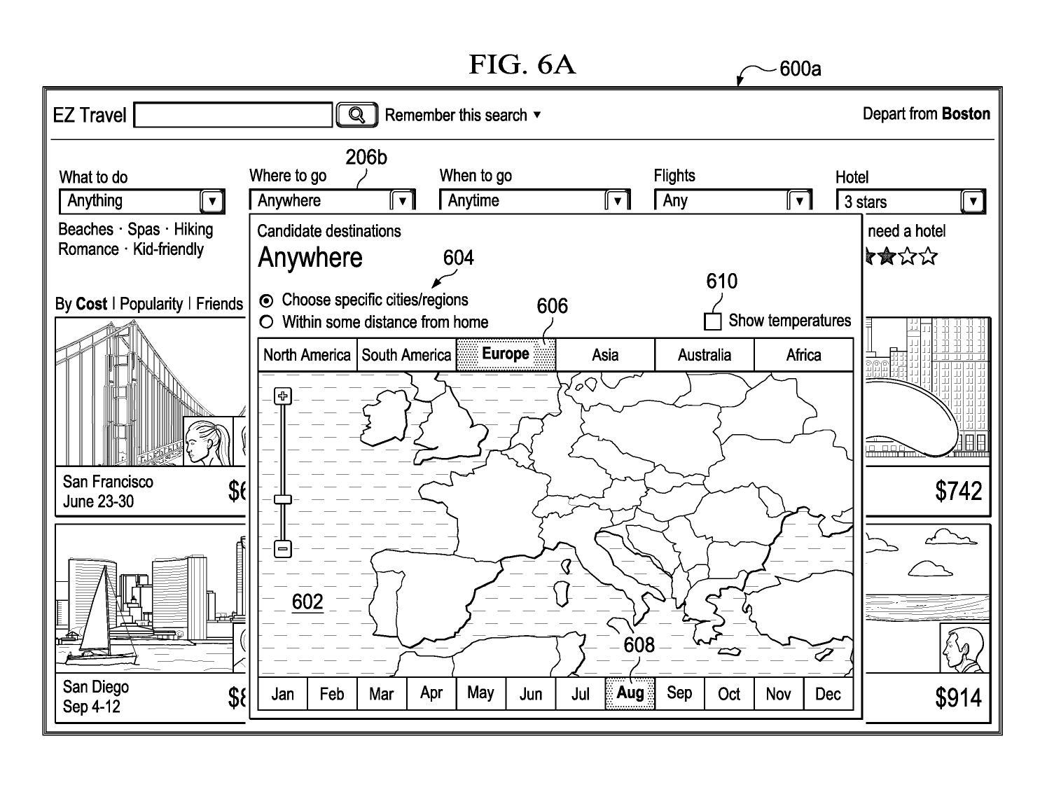

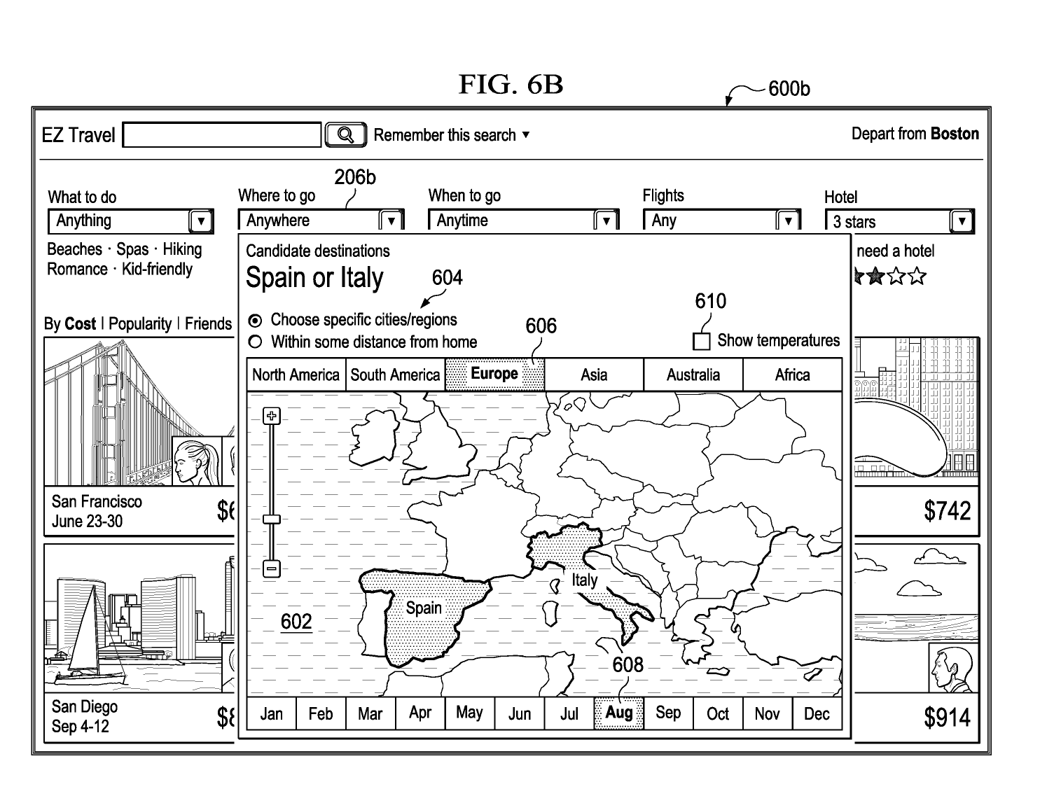

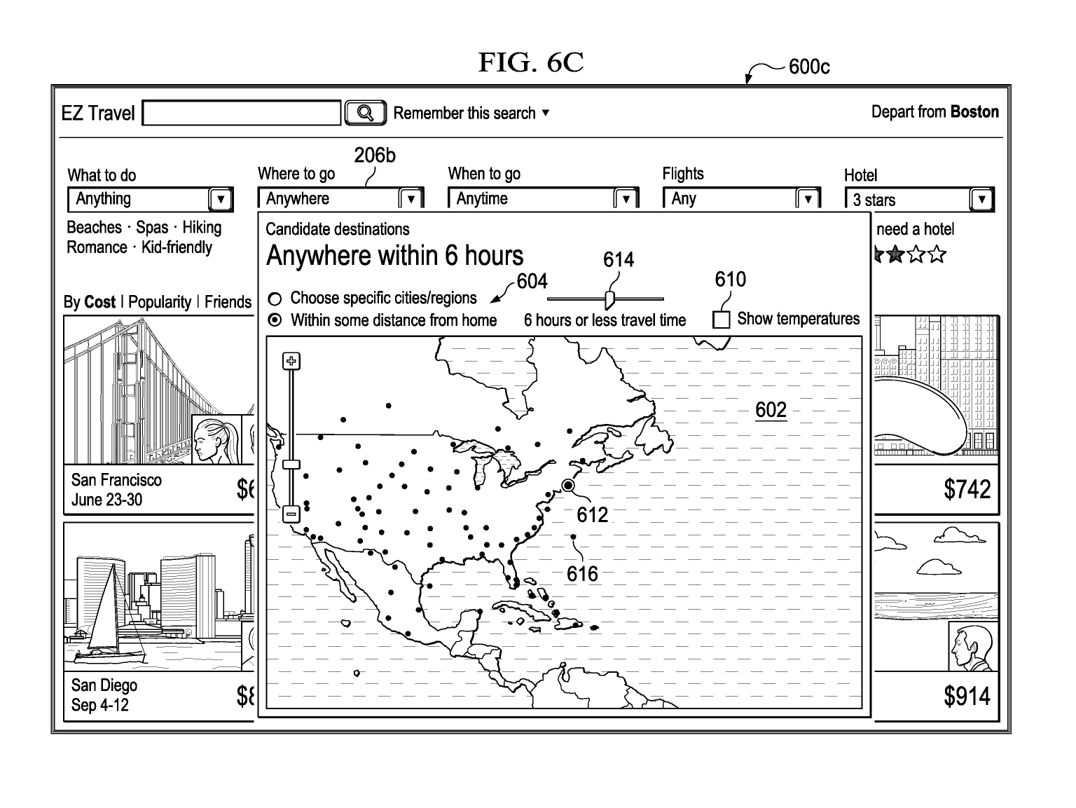

FIG. 6A illustrates an example screenshot 600a of an expanded “Where to go” entry element according to one implementation. Here, the VCG presents a user a map GUI 602 with zoom control. In some implementations, the user can also select and drag the map within the map GUI 602. Also provided are candidate selection options 604 (“Choose specific cities/regions” and “Within some distance from home”). A user can also select various regions 606. Here, “Europe” is selected as reflected in the map GUI 602. The user also has the ability to select one or more month options 608. Here, “Aug” is selected indicating that the user wishes to visit the displayed region sometime in the month of August. Also provided is the option for the user to show temperatures 610 associated with the regions, cities, etc. Temperature values can be real-time or projections based on historical data. In some implementations, actual and projected temperature values can be differentiated by color, pattern, size, or other suitable GUI method. As displayed, the VCG understands that the user wishes to visit Europe sometime in the month of August and does not wish to view temperature data.

FIG. 6B illustrates an example screenshot 600b of an expanded “Where to go” entry element with selected countries according to one implementation. Here, the user has selected both “Spain” and “Italy” from the map GUI 602. These selections indicate to the TPCS 100 that the user wishes to visit either Spain or Italy in Europe sometime in the month of August and does not wish to view temperature data. In some implementations (not illustrated), the user can zoom down into a specified country and pick a specific city or cities. For example, the user could select “Germany” from the map GUI 602 and after zooming to a level where cities are visible, select “Munich,” “Frankfurt,” and “Heidelberg” from the map GUI 602. This would indicate that the user wishes to visit one or more of the three indicated cities in Germany in Europe in the month of August and does not wish to view temperature data. Proposed vacation destinations associated with the user request will be generated and displayed to the user. In some implementations, the user can indicate regions to purposely exclude from consideration. For example, the user may have Europe selected as region 606 and indicate that “Spain” and “Italy” are to instead be excluded from consideration. This reverse-type functionality maybe part of settings associated with the user profile data 120 or other suitable data.

FIG. 6C illustrates an example screenshot 600c of an expanded “Where to go” entry element using a within some distance from home option according to one implementation. Here, the user has selected the “Within some distance from home” option 604. This changes the map GUI 602 to display the geographic origin 612 of the user, here, for example, the United States of America in Boston, Mass. In some implementations, the origin is indicated differently than other data points. For example, here, the geographic origin 612 is indicated by a larger blue filled circle. Travel time slider 614 allows the user to specify a travel time maximum. Based on the slider value of “6 hours or less travel time,” the VCG indicates with green-filled circles one or more proposed vacation destination 616 points within six hours or less of Boston, Mass. Note that these proposals are for travel by air carrier. In some implementations, users can be presented the option to change transportation types using available GUI elements (not illustrated). For example, a pull-down menu could provide different transportation options of automobile, bus, boat/ship, train, subway, and other suitable transportation options. In some instances, the user can select multiple transportation options and the resultant proposed vacation destination can be appropriately displayed to indicate the transportation types, for example, by color, pattern, size, and the like.

In some implementations, the user can “hover” over or select the proposed vacation destination and the geographic origin and be provided additional data, for example, in a pop-up dialog. For example, the user could select a proposed vacation destination 616 and receive information on Bermuda.

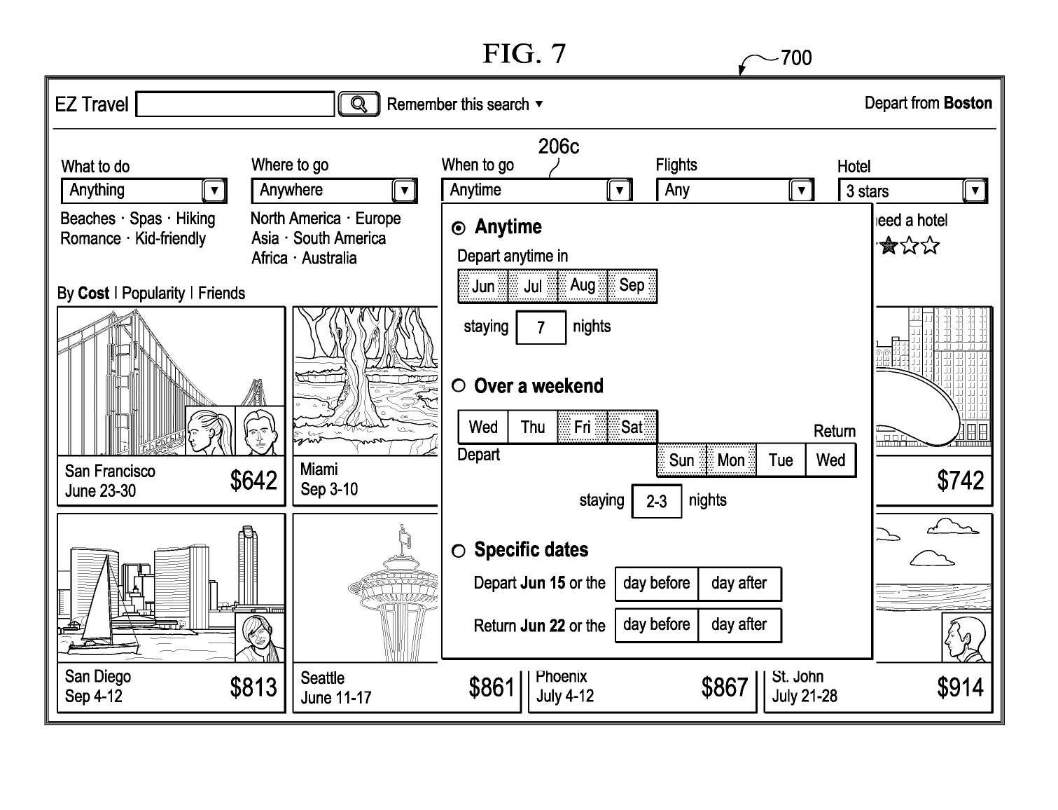

FIG. 7 illustrates an example screenshot 700 of an expanded “When to go” entry element 206c according to one implementation. Here, a user has the option to select date value and time ranges. For example, the user can select “Anytime” and select an anytime “range” such as specific months and numbers of nights. The user can also select “Over a weekend” and specify a departure day/date, return day/date, and number of nights. The user can also select “Specific dates” for a vacation. Other suitable methods and functionality to perform these date selections are also envisioned.

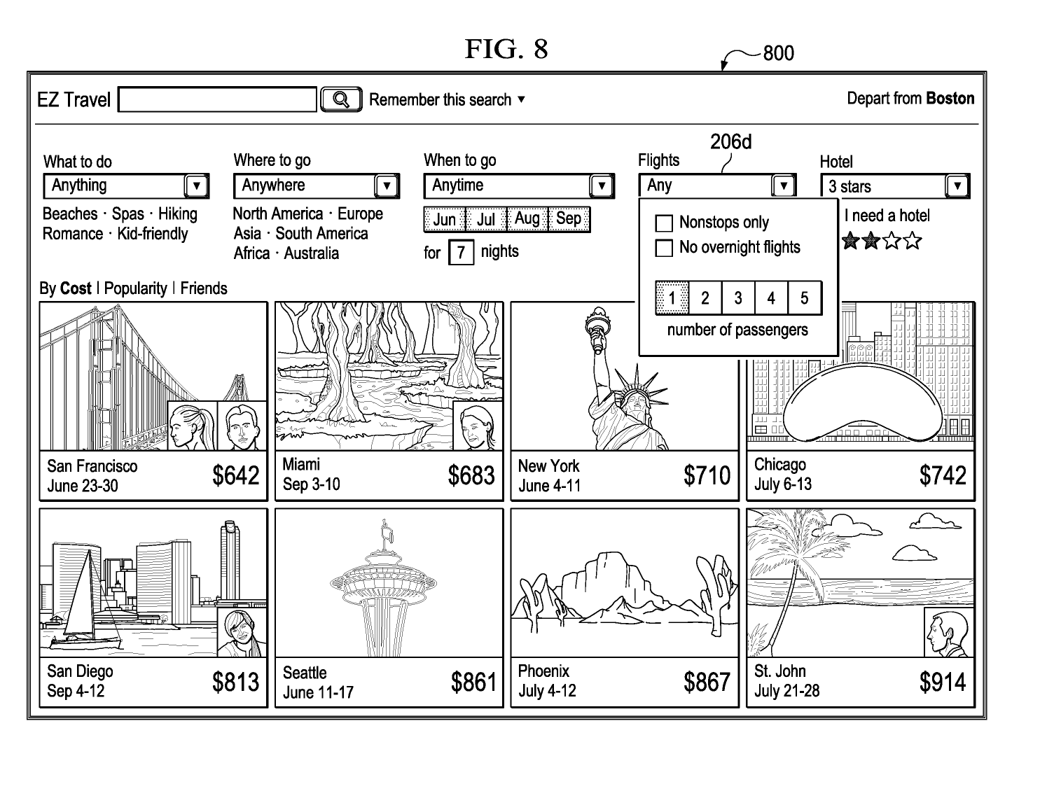

FIG. 8 illustrates an example screenshot 800 of an expanded “Flights” entry element 206d according to one implementation. Here, a user has an option to specify data applicable to air carrier flights. For example, the user can specify “nonstop only,” “No overnight flights,” and a number of passengers. In other implementations, users can be presented the option to change transportation type using available GUI elements (not illustrated). For example, “Flights” could be changed to a different transportation option of automobile, bus, boat/ship, train, subway, and other suitable transportation option. In some instances, the user can select multiple transportation options.

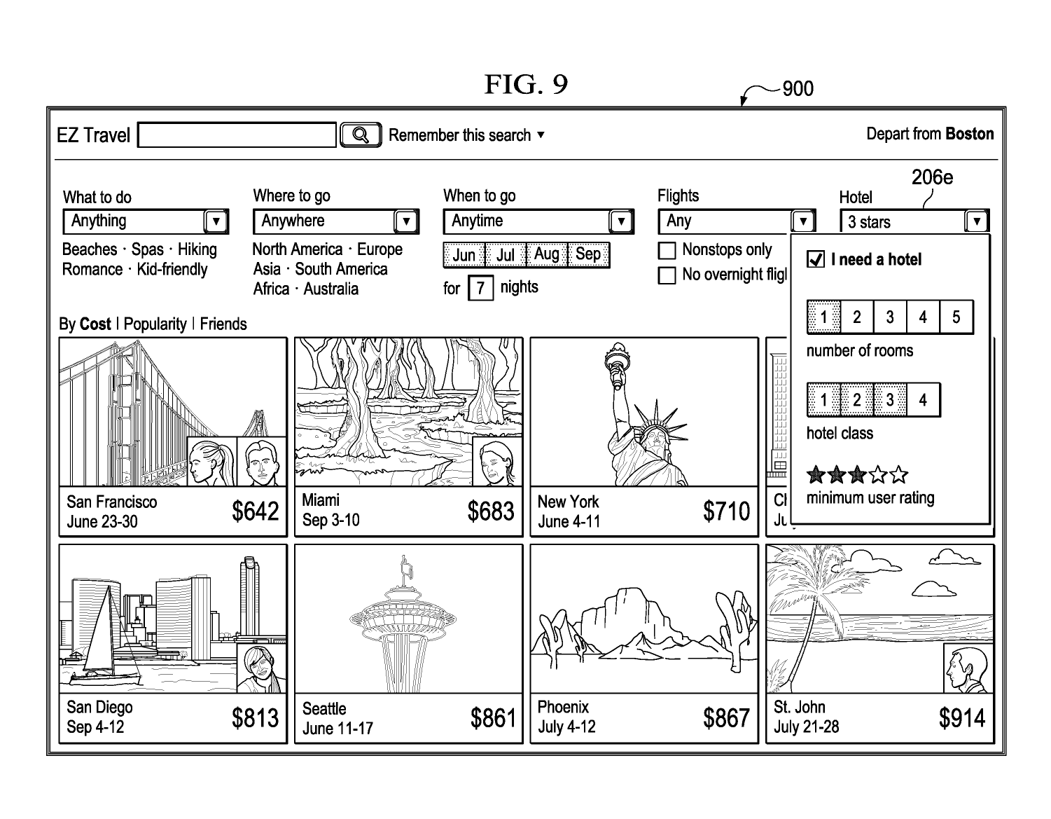

FIG. 9 illustrates an example screenshot 900 of an expanded “Hotel” entry element 206e according to one implementation. Here, a user has an option to specify data applicable to hotels. For example, the user can specify “I need a hotel,” number of rooms needed, hotel class, and a minimum user rating. In other implementations, users can be presented the option to change lodging type using available GUI elements (not illustrated). For example, “Hotel” could be changed to a different lodging option of motel, bed-and-breakfast, apartment, local house room for rent, dorm, and other suitable lodging option. In some instances, the user can select multiple lodging options.

FIG. 10 illustrates an example screenshot 1000 of provided details for a selected proposed vacation destination. Here, the user has selected proposed vacation destination element 210a by an appropriate means, for example, clicking with a computer mouse, selecting with a touch screen, and the like. The VCG “overlays” specific details about/options associated with “San Francisco” in the VCG. For example, contextual options 1002 for “To Do,” “About,” “Friends,” and the like are presented. Here, the “To do” option is highlighted. Underneath the contextual options 1002, focused options 1004 are presented. Here, the user is presented with options such as “All,” “Architecture,” “Art,” “Culture,” “Dance,” and the like. The description element image is also replicated along with a number of smaller images 1006 representing the focus options 1004. In some implementations, hovering over the images can present the user with additional details concerning the specific focused option value, for example, in a pop-up window. In this example, “Golden Gate Park” is proposed by the VCG as a primary attraction along with a history of the park below the image. In addition, an interactive price-date summary graph 1008 as described in FIG. 2 is presented to the user and provides similar functionality. Note that temperature data is provided in this example and is associated with the slider and selected date. The user is also presented with additional data 1010 regarding cost of travel and lodging associated with San Francisco. Here, flights associated with San Francisco are indicated as “from $354” and lodging “from $288.” In some implementations, these values are selectable and will open up appropriate GUIs to handle transactions.

The VCG also provides an option 1012 to add “San Francisco” to a “short list” 1014 for quick future reference. For example, the option 1012 could have read “Add to shortlist” (e.g., see 1012 on FIG. 11) and, when selected, an icon for San Francisco was added as 1014 and the text of button 1012 changed to reflect “On shortlist.” The selection of the icon 1014 from another state of the VCG would return the VCG to a state equal to or similar to that as illustrated in FIG. 10.

FIG. 11 illustrates an example screenshot 1100 of alternative provided details for a selected proposed vacation destination. Here, a user had either selected “Paris” from the “Where to go” entry element 206b or typed “Paris” into the search box 202. The VCG “overlays” specific details about/options associated with “Paris” in the VCG. In this example, the details fill most of the VCG (as compared to FIG. 10). The functionality and data displayed are consistent with that described in FIG. 10.

FIG. 12 is a flow chart of an example method 1200 for comparing costs of vacation components. For clarity of presentation, the description that follows generally describes method 1200 in the context of FIGS. 1-5, 6A-6C, and 7-11. However, it will be understood that method 1200 may be performed, for example, by any other suitable system, environment, software, and hardware, or a combination of systems, environments, software, and hardware as appropriate.

At 1202, a geographic origin for a received request to initiate a vacation planning session is determined. In some implementations, the geographic origin is determined by at least one of data entry, analysis of an Internet protocol (IP) address, location-based data obtained from a mobile device, global positioning system (GPS) data, or cellular network triangulation data. From 1202, method 1200 proceeds to 1204.

At 1204, a plurality of proposed vacation destinations are selected. From 1204, method 1200 proceeds to 1206.

At 1206, vacation information comprising a location indicator, a vacation date range, and a lowest price associated with the vacation date range are identified for each proposed vacation destination of the plurality of vacation destinations. From 1206, method 1200 proceeds to 1208.

At 1208, the selected plurality of proposed vacation destinations is filtered based upon at least one filtering rule based at least in part upon the determined geographic origin to generate a set of filtered proposed vacation destinations. In some implementations, the proposed vacation destinations are filtered based one or more particular values associated with user profile data. In other implementations, the at least one filtering rule is used to weight each proposed vacation destination. From 1208, method 1200 proceeds to 1210.

At 1210, a presentation of all or part of the vacation information for the set of filtered proposed vacation destinations is initiated. Each proposed vacation destination of the filtered proposed vacation destinations is associated with an interactive informational element, for example, a GUI element, representing the proposed vacation destination. From 1210, method 1200 proceeds to 1212.

At 1212, a determination is made whether a hover event associated with a proposed vacation destination interactive informational element is received. If a hover event was not received, method 1200 returns to 1212. If a hover event was received, method 1200 proceeds to 1214.

At 1214, a presentation of an interactive price-date summary graph for the proposed vacation destination associated with the particular interactive informational element is initiated. From 1214, method 1200 proceeds to 1216.

At 1216, a determination is made whether a price-date summary graph selector adjustment event was received. If an adjustment event was not received, method 1200 returns to 1216. If an adjustment event was received, method 1200 proceeds to 1218.

At 1218, vacation information associated with the proposed vacation destination interactive informational element is updated. After 1218, method 1200 stops.

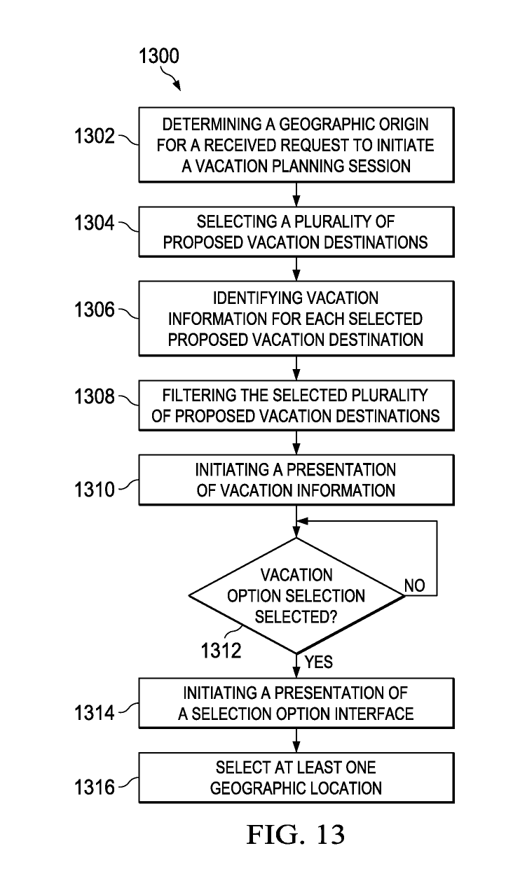

FIG. 13 is a flow chart of an example alternative method 1300 for comparing costs of vacation components. For clarity of presentation, the description that follows generally describes method 1300 in the context of FIGS. 1-5, 6A-6C, and 7-12. However, it will be understood that method 1300 may be performed, for example, by any other suitable system, environment, software, and hardware, or a combination of systems, environments, software, and hardware, as appropriate.

At 1302, a geographic origin for a received request to initiate a vacation planning session is determined. In some implementations, the geographic origin is determined by at least one of data entry, analysis of an Internet protocol (IP) address, location-based data obtained from a mobile device, global positioning system (GPS) data, or cellular network triangulation data. From 1302, method 1300 proceeds to 1304.

At 1304, a plurality of proposed vacation destinations are selected. From 1304, method 1300 proceeds to 1306.

At 1306, vacation information comprising a location indicator, a vacation date range, and a lowest price associated with the vacation date range are identified for each proposed vacation destination of the plurality of vacation destinations. From 1306, method 1300 proceeds to 1308.

At 1308, the selected plurality of proposed vacation destinations is filtered based upon at least one filtering rule based, at least in part, upon the determined geographic origin to generate a set of filtered proposed vacation destinations. In some implementations, the proposed vacation destinations are filtered based on one or more particular values associated with user profile data. In other implementations, the at least one filtering rule is used to weight each proposed vacation destination. From 1308, method 1300 proceeds to 1310.

At 1310, a presentation of all or part of the vacation information for the set of filtered proposed vacation destinations is initiated. Each proposed vacation destination of the filtered proposed vacation destinations is associated with an interactive informational element, for example, a GUI element, representing the proposed vacation destination. From 1310, method 1300 proceeds to 1312.

At 1312, a determination is made whether an indication that a vacation destination selection option has been selected. If a vacation destination selection option has not been selected, method 1300 returns to 1312. If a vacation destination selection option has been selected, method 1300 proceeds to 1314.

At 1314, a presentation of a selection option interface is initiated. In some implementations, the selection option interface provides the capability to select at least one specific geographic location, for example, from a map, as a vacation destination. The geographic location is also associated with a geographic category, such as “Europe,” “North America,” and the like. In some implementations, the geographic category can be dependent upon a geographical zoom value. For example, if the zoom value is high, the geographic category can change and/or add categories such as “city,” “town,” “neighborhood,” and the like. In some implementations, the selection of a geographic region, location, etc. can act to filter the selected geographic region, location, etc. from consideration for proposed vacation destinations. From 1314, method 1300 proceeds to 1316.

At 1316, at least one geographic location is selected using the selection option interface. After 1316, method 1300 stops.

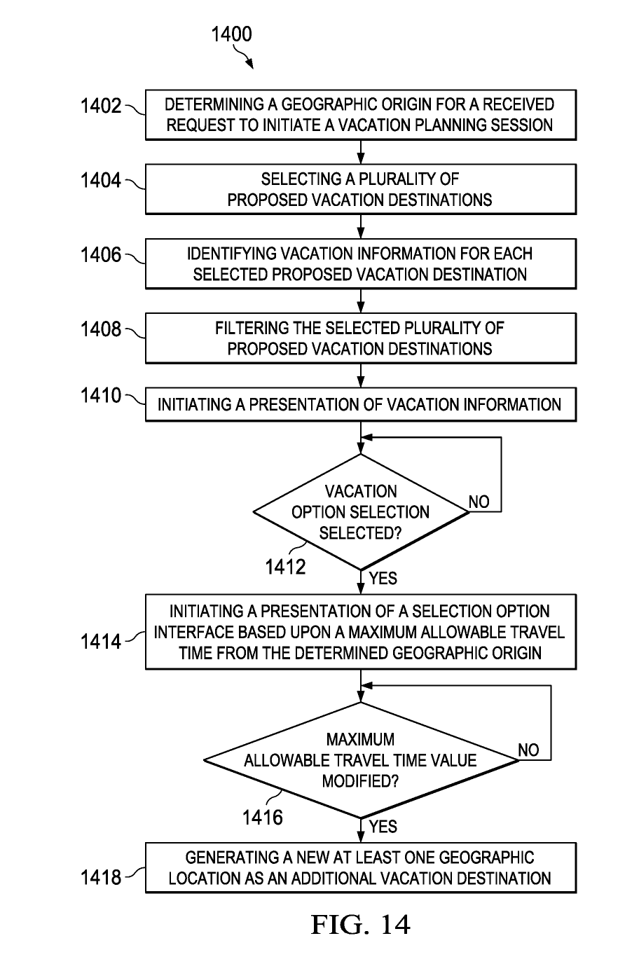

FIG. 14 is a flow chart of an example alternative method 1400 for comparing costs of vacation components. For clarity of presentation, the description that follows generally describes method 1400 in the context of FIGS. 1-5, 6A-6C, and 7-13. However, it will be understood that method 1400 may be performed, for example, by any other suitable system, environment, software, and hardware, or a combination of systems, environments, software, and hardware, as appropriate.

At 1402, a geographic origin for a received request to initiate a vacation planning session is determined. In some implementations, the geographic origin is determined by at least one of data entry, analysis of an Internet protocol (IP) address, location-based data obtained from a mobile device, global positioning system (GPS) data, or cellular network triangulation data. From 1402, method 1400 proceeds to 1404.

At 1404, a plurality of proposed vacation destinations are selected. From 1404, method 1400 proceeds to 1406.

At 1406, vacation information comprising a location indicator, a vacation date range, and a lowest price associated with the vacation date range are identified for each proposed vacation destination of the plurality of vacation destinations. From 1406, method 1400 proceeds to 1408.

At 1408, the selected plurality of proposed vacation destinations is filtered based upon at least one filtering rule based at least in part upon the determined geographic origin to generate a set of filtered proposed vacation destinations. In some implementations, the proposed vacation destinations are filtered based one or more particular values associated with user profile data. In other implementations, the at least one filtering rule is used to weight each proposed vacation destination. From 1408, method 1400 proceeds to 1410.

At 1410, a presentation of all or part of the vacation information for the set of filtered proposed vacation destinations is initiated. Each proposed vacation destination of the filtered proposed vacation destinations is associated with an interactive informational element, for example, a GUI element, representing the proposed vacation destination. From 1410, method 1400 proceeds to 1412.

At 1412, a determination is made whether an indication that a vacation destination selection option has been selected. If a vacation destination selection option has not been selected, method 1400 returns to 1412. If a vacation destination selection option has been selected, method 1400 proceeds to 1414

At 1414, a presentation of a selection option interface is initiated. In some implementations, the selection option interface provides the capability to select a maximum allowable travel time from the determined geographic origin, for example, six hours. For example, in some implementations, a user can manipulate a slider-type GUI element to vary a maximum allowable travel time value. Based on the value, the VCG displays proposed vacation destinations within the maximum allowable travel time value. From 1414, method 1400 proceeds to 1416.

At 1416, a determination is made whether a maximum allowable travel time value was modified. If the maximum allowable travel time value was not modified, method 1400 returns to 1416. If the maximum allowable travel time value was modified, method 1400 proceeds to 1418.

At 1418, at least one new geographic location is generated and presented in the selection option interface as an additional vacation destination. After 1418, method 1400 stops.

While, FIGS. 2-5, 6A-6C, and 7-11 illustrate and describe various example GUIs, these example GUIs are meant only as representative examples of many possible implementations and are not meant to limit in any way GUI functionality and implementations for comparing costs of vacation components. Those of skill in the art will appreciate the multitude of possible implementations that may be used to accomplish the described functionality.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled, to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method to render graphical user interfaces to compare values of components, comprising:
receiving, by one or more computing devices from a user computing device, a request to initiate a planning session;
determining, by one or more computing devices, a geographic origin for the received request to initiate the planning session, wherein the geographic origin is determined based on data received from the user computing device;
generating, by the one or more computing devices, a set of proposed destinations based on the received request and the determined geographic origin;
for each proposed vacation destination of the set of proposed destinations, identifying, by the one or more computing devices, information comprising a location indicator, a date range, and a lowest value of a bundle associated with the date range;
providing, using the one or more computing devices, instructions to the user computing device causing the user computing device to render, via a graphical user interface, a presentation of all or part of the information for the set of proposed destinations, wherein each proposed destination of the set of proposed destinations is associated with an interactive informational element representing the corresponding proposed destination;
receiving, using the one or more computing devices from the user computing device, a selection, via the graphical user interface, of a particular interactive informational element for a corresponding proposed destination; and
providing, using the one or more computing devices, instructions to the user computing device to update the graphical user interface to render, via the updated graphical user interface, a display of an interactive value-date summary graph for the corresponding proposed destination associated with the particular interactive information element, a first axis of the value-date summary graph comprising two or more dates and a second axis of the value-date summary graph comprising a range of values for the bundle associated with the corresponding proposed destination.

2. The computer-implemented method of claim 1, wherein the geographic origin is determined by at least one of analysis of an Internet protocol (IP) address, location-based data obtained from a user computing device, global positioning system (GPS) data, or cellular network triangulation data.

3. The computer-implemented method of claim 1, wherein the proposed destinations are filtered based one or more particular values associated with user profile data.

4. The computer-implemented method of claim 3, wherein at least one filtering rule is used to weight each proposed destination.

5. The computer-implemented method of claim 1, further comprising updating the information associated with the proposed destination upon receiving a selector adjustment event for a selector associated with the interactive value-date summary graph.

6. The computer-implemented method of claim 1, wherein the selection comprises a hover event.

7. A computer program product, comprising:
a non-transitory computer-readable storage device having computer-readable program instructions embodied therein that when executed by a computer cause the computer to render graphical user interfaces to compare values of components, the computer-readable program instructions comprising:
computer-readable program instructions to receive, from a user computing device, a request to initiate a planning session;
computer-readable program instructions to determine a geographic origin for the received request to initiate the planning session, wherein the geographic origin is determined based on data received from the user computing device;
computer-readable program instructions to generate a set of proposed destinations based on the received request and the determined geographic origin;
computer-readable program instructions to identify, for each proposed vacation destination of the set of proposed destinations, information comprising a location indicator, a date range, and a lowest value of a bundle associated with the date range;
computer-readable program instructions to provide instructions to the user computing device causing the user computing device to render, via a graphical user interface, a presentation of all or part of the information for the set of proposed destinations, wherein each proposed destination of the set of proposed destinations is associated with an interactive informational element representing the corresponding proposed destination;
computer-readable program instructions to receive, from the user computing device, a selection, via the graphical user interface, of a particular interactive informational element for a corresponding proposed destination; and
computer-readable program instructions to provide instructions to the user computing device to update the graphical user interface to render, via the updated graphical user interface, a display of an interactive value-date summary graph for the corresponding proposed destination associated with the particular interactive information element, a first axis of the value-date summary graph comprising two or more dates and a second axis of the value-date summary graph comprising a range of values for the bundle associated with the corresponding proposed destination.

8. The computer program product of claim 7, wherein the geographic origin is determined by at least one of data entry, analysis of an Internet protocol (IP) address, location-based data obtained from a user computing device, global positioning system (GPS) data, or cellular network triangulation data.

9. The computer program product of claim 7, wherein the proposed destinations are filtered based one or more particular values associated with user profile data.

10. The computer program product of claim 9, wherein at least one filtering rule is used to weight each proposed destination.

11. The computer program product of claim 7, wherein the selection comprises a hover event.

12. The computer program product of claim 7, wherein the geographic zoom value determines a specificity of displayed geographic data within the selection option interface.

13. The computer program product of claim 7, wherein the graphical user interface comprises a selection option interface allowing the selection of a geographic region to filter displayed geographic data to geographic data associated with the selected geographic region, wherein the selection option interface allows the selection of a geographic region to filter displayed geographic data to geographic data associated with the selected geographic region.

14. A system to render graphical user interfaces to compare values of components, comprising:
a storage device; and
a processor communicatively coupled to the storage device, wherein the processor executes application code instructions that are stored in the storage device to cause the system to:
receive, from a user computing device, a request to initiate a planning session;
determine a geographic origin for the received request to initiate the planning session, wherein the geographic origin is determined based on data received from the user computing device;
generate a set of proposed destinations based on the received request and the determined geographic origin;
identify, for each proposed vacation destination of the set of proposed destinations, information comprising a location indicator, a date range, and a lowest value of a bundle associated with the date range;
provide instructions to the user computing device causing the user computing device to render, via a graphical user interface, a presentation of all or part of the information for the set of proposed destinations, wherein each proposed destination of the set of proposed destinations is associated with an interactive informational element representing the corresponding proposed destination;
receive, from the user computing device, a selection, via the graphical user interface, of a particular interactive informational element for a corresponding proposed destination; and
provide instructions to the user computing device to update the graphical user interface to render, via the updated graphical user interface, a display of an interactive value-date summary graph for the corresponding proposed destination associated with the particular interactive information element, a first axis of the value-date summary graph comprising two or more dates and a second axis of the value-date summary graph comprising a range of values for the bundle associated with the corresponding proposed destination.

15. The system of claim 14, wherein the geographic origin is determined by at least one of analysis of an Internet protocol (IP) address, location-based data obtained from a user computing device, global positioning system (GPS) data, or cellular network triangulation data.

16. The system of claim 14, wherein the proposed destinations are filtered based one or more particular values associated with user profile data.

17. The system of claim 16, wherein at least one filtering rule is used to weight each destination.

18. The system of claim 14, wherein the selection comprises a hover event.

19. The system of claim 14, wherein the graphical user interface comprises a selection option interface allowing the selection of a geographic region to filter displayed geographic data to geographic data associated with the selected geographic region.

20. The system of claim 14, wherein a geographic zoom value determines a specificity of displayed geographic data within the selection option interface.
